(19) United States
(12) Patent Application Publication
(10) Pub. No.: US 2005/0134569 A1
(43) Pub. Date: Jun. 23, 2005

(54) Accelerated dual-display

(76) Inventors: Marcus Grindstaff, Folsom, CA (US); Lawrence A. Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,486

(22) Filed: Dec. 23, 2003

(51) Int. Cl. G09G 1/06; G09G 5/00

(52) U.S. Cl. 345/169

(57) ABSTRACT

An accelerated dual display enabling a user to dynamically decide which graphics subsystem will run which display on a handheld device. The dual display system has an application processor and an external chip. A crossbar located in the external chip connects the application processor to the external chip. Displays are connected to the crossbar.

### BACKGROUND INFORMATION

There are currently two methods that are used for dual-display implementations. These include 1) separate graphic subsystems statically driving separate displays and 2) integration of two (or more) graphics subsystems into a single silicon device that drives several displays. However, for handheld device, each of these methods has significant disadvantages.

One disadvantage of using separate graphics subsystems statically driving separate displays requires that the graphics subsystem for each display be statically chosen during system design. Another disadvantage is the cost, power, form-factor and system architecture issues with this type of implementation. Thus, there is a need for an accelerated dual display that allows for dynamic assignment of each graphics subsystem to each display, without the significant disadvantages of cost, power, or form-factor.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is block diagram of an accelerated dual display.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

It is becoming an increasing requirement for handheld devices to support dual-display capability. Devices expected to accommodate dual display may include PDAs, communicators, tablets/smart monitors and handheld gaming devices. Since so many devices are expected to accommodate dual displays it is important that a system solution be developed that can meet this need by providing maximum flexibility and performance, while still keeping costs to a minimum. Additionally, as dual display capability is not required for all platforms, it is important to accommodate dual display without placing additional cost or complexity burden on an application processor.

For the purposes of this application, a handheld device such as a PDA will be used as an example. A typical PDA includes an integrated LCD display. For purposes of this application this will be known as the “integrated display”. Furthermore, many PDAs have the capability to drive an external display such as a monitor, digital projector, television, etc. For purposes of this application this will be known as the “external display”. It is not a requirement of this invention that one of the displays be integrated and one of the displays be external. Additionally, for purposes of this application the term component will refer to one or more packaged silicon devices. The term device will refer to a handheld system including but not limited to a PDA, communicator or tablet.

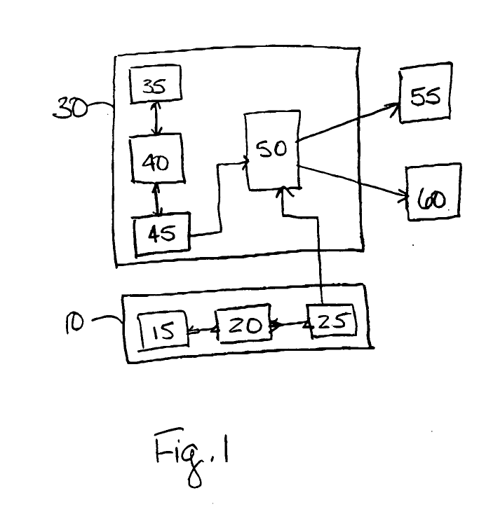

FIG. 1 is an accelerated dual display of the present invention. The bottom device is an application processor 10. The application processor 10 includes a graphics subsystem. The graphics subsystem may include a graphics engine 15, a frame buffer 20 and a display controller 25. These three devices are typically integrated into a single component. The graphics engine 15 is responsible for processing graphics data and the display controller 25 is responsible for driving displays. Usually, the display controller 25 is driven by the graphics engine 15. Sometimes the graphics engine 15 may not implemented in dedicated graphics hardware, the graphics engine 15 may be a microprocessor controller via software that is responsible for manipulating graphics data.

The top device may be an external graphic chip 30 that has the higher performance. The external graphics chip 30 also includes a graphics subsystem. As stated above the graphics subsystem may be comprised of a graphics engine 35, a frame buffer 40 and a display controller 45. The external graphics chip 30 further includes a crossbar/display switch 50. The display controller 25 of the application processor 10 and the display controller 45 of the external chip 30 are both attached to the display switch 50. Two displays 55, 60 are attached to the display switch 50. By having the displays 55, 60 attached to the crossbar 50 enables an user to dynamically decide that a given display 55, 60 should be driven by a given graphics subsystem.

For example, assume a user has a PDA device and the PDA has an integrated LCD controller. When using the PDA in a stand alone configuration, the integrated PDA display should be driven by the graphics chip 30, thus delivering the highest quality graphics to the integrated display. However, when the PDA is connected to an external display, the graphics chip 30 should drive the external display, and the less capable graphics subsystem in the application processor 10 should drive the integrated display. This allows the best graphics on the best display thereby providing higher resolutions on the external display. The decision to switch between which graphics subsystem will run which display is done dynamically and no longer needs to be statically chosen during system design.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A device comprising:
one or more graphics subsystems;
a display switch coupled to the one or more graphics subsystem; and
one or more display outputs coupled to the display switch.

2. The device of claim 1 wherein the one more graphics subsystem comprise of a graphics engine, a memory and a display controller.

3. The device of claim 2 wherein the display controller is coupled to the display switch.

4. The device of claim 1 wherein the device can be a PDA.

5. The device of claim 1 wherein the display switch can dynamically switch which of the one or more graphics subsystem is running the one or more display outputs.

6. An accelerated dual display comprising:
a first subsystem;
a second subsystem;
a crossbar connecting the first and second subsystems; and
one or more displays connected to the crossbar.

7. The dual display of claim 6 wherein the crossbar can independently switch which of the first and second subsystems is running the one or more displays.

8. The dual display of claim 6 wherein the dual display is a PDA.

9. The dual display of claim 6 wherein the first and second subsystem are comprised of a graphics engine, a memory and a display controller.

10. The dual display of claim 9 wherein the display controller is connected to the crossbar.

11. The dual display of claim 6 wherein the crossbar is comprised within the second subsystem.
